(19) United States
(12) Patent Application Publication
(10) Pub. No.: US 2025/0189757 A1
(43) Pub. Date: Jun. 12, 2025

(54) OPERATION RING, LENS DEVICE, AND METHOD OF MANUFACTURING OPERATION RING

(71) Applicant: FUJIFILM Corporation, Tokyo (JP)

(72) Inventor: Nobuyuki KONDO, Saitama (JP)

(73) Assignee: FUJIFILM Corporation, Tokyo (JP)

(21) Appl. No.: 19/059,226

(22) Filed: Feb. 20, 2025

Related U.S. Application Data
(63) Continuation of application No. PCT/JP2023/029599, filed on Aug. 16, 2023.

(30) Foreign Application Priority Data
Aug. 22, 2022 (JP) 2022-131824

(51) Int. Cl. G02B 7/105; G02B 7/02; G02B 7/10; G03B 17/14

(52) U.S. Cl. CPC G02B 7/105; G02B 7/021; G02B 7/026; G02B 7/102; G03B 17/14; G03B 2205/0046

(57) ABSTRACT

A lens barrel includes a zoom ring, an optical system, and an electric zoom mechanism that drives a zoom lens group in accordance with rotation of the zoom ring. The zoom ring includes a ring member and a pattern portion, the pattern portion has a first pattern portion having first light reflectivity and a second pattern portion having second light reflectivity, the first light reflectivity is higher than the second light reflectivity, an inner peripheral surface of the ring member has a first surface portion parallel to a rotation axis of the ring member and a second surface portion inclined with respect to the rotation axis, and printing is performed on the first surface portion to form the pattern portion.

### CROSS-REFERENCE TO RELATED APPLICATIONS

This application is a Continuation of PCT International Application No. PCT/JP2023/029599 filed on 16 Aug. 2023, which claims priority under 35 U.S.C § 119 (a) to Japanese Patent Application No. 2022-131824 filed on 22 Aug. 2022. The above application is hereby expressly incorporated by reference, in its entirety, into the present application.

### BACKGROUND OF THE INVENTION

### 1. Field of the Invention

The present invention relates to an operation ring, a lens device, and a method of manufacturing an operation ring.

### 2. Description of the Related Art

JP6973398B describes a lens device comprising an operation ring that is rotated, a light-emitting element that emits light, and a plurality of light-receiving elements, and is provided with a detection pattern portion having a reflective surface and a non-reflective surface that are alternately disposed in a rotation direction of the operation ring and that move with the rotation of the operation ring. The light-emitting element emits light to a detection pattern portion, and the plurality of light-receiving elements are disposed on the same substrate as the light-emitting element and receive reflected light from the reflective surface.

An imaging apparatus described in JP2021-071541A (corresponding to US2021/0124142A1) includes an optical member, a focus motor for moving the optical member, a lens central processing unit (CPU) that controls the focus motor, an operation member including a reflective portion that constitutes a circuit and a low reflective portion having reflectivity lower than reflectivity of the reflective portion, and a photoreflector that receives light reflected by the reflective portion, in which the lens CPU controls the focus motor in accordance with output from the photoreflector.

### SUMMARY OF THE INVENTION

One embodiment according to the technology of the present disclosure provides an operation ring and a lens device capable of detecting a rotation position with a high resolution in a case in which a rotation operation is performed and suppressing an increase in cost, and a method of manufacturing an operation ring.

An aspect of the technology of the present disclosure provides an operation ring comprising: a ring member; and a pattern portion, in which the pattern portion has a first pattern portion having first light reflectivity and a second pattern portion having second light reflectivity, the first light reflectivity is higher than the second light reflectivity, an inner peripheral surface of the ring member has a first surface portion parallel to a rotation axis of the ring member and a second surface portion inclined with respect to the rotation axis, and printing is performed on the first surface portion to form the pattern portion. The ring member includes a resin member. The pattern portion serves as an indicator of a rotation operation of the ring member.

It is preferable that the first pattern portion coated with paint is formed on the first surface portion. It is preferable that the paint contains a metal material, and a mixing ratio of the metal material in the paint is 25% or more and 45% or less.

It is preferable that the second surface portion includes an one-end-side second surface portion located on one end side in an axial direction of the rotation axis and an other-end-side second surface portion located on the other end side, and the first surface portion is located between the one-end-side second surface portion and the other-end-side second surface portion in the axial direction.

It is preferable that a first inclination angle at which the one-end-side second surface portion is inclined with respect to the axial direction is larger than a second inclination angle at which the other-end-side second surface portion is inclined with respect to the axial direction.

It is preferable that the ring member has a stepped portion located outside or inside the first surface portion in a radial direction. It is preferable that, in a case in which the stepped portion is located inside the first surface portion in the radial direction, the one-end-side second surface portion and the other-end-side second surface portion are located outside the stepped portion in the radial direction.

It is preferable that, in a case in which the stepped portion is located outside the first surface portion in the radial direction, an innermost diameter portion in which an inner diameter of the ring member is minimized is present inside the first surface portion in the radial direction, and the other-end-side second surface portion is disposed at a position continuous to the innermost diameter portion.

It is preferable that the ring member has a stepped portion located inside the second surface portion in a radial direction, and the stepped portion has the first surface portion, in which the first pattern portion is printed on the first surface portion.

It is preferable that a material of the operation ring is a carbon fiber composite material. It is preferable that, in the pattern portion, the first pattern portion and the second pattern portion are alternately disposed in a circumferential direction of the operation ring. It is preferable that the first pattern portion and the second pattern portion are disposed to have the same width. It is preferable that the width is 0.2 mm or more and 0.3 mm or less.

Another aspect of the technology of the present disclosure provides a lens device comprising: the operation ring described above; an optical system; and an electric zoom mechanism that drives a zoom lens group that is a part of the optical system, in accordance with rotation of the operation ring.

It is preferable that the optical system includes at least the zoom lens group, a first lens group, a filter, and a stop, the filter has a maximum outer diameter portion larger than a maximum outer diameter portion of the first lens group and is located on a subject side with respect to the first lens group, the zoom lens group is located between the first lens group and the stop and on the subject side with respect to the stop, and the pattern portion is located between the maximum outer diameter portion of the first lens group and the maximum outer diameter portion of the filter.

Still another aspect of the technology of the present disclosure provides a method of manufacturing an operation ring, the method comprising: a step of forming a ring member including a resin member, the ring member having, on an inner peripheral surface, a first surface portion parallel to a rotation axis of the ring member and a second surface portion inclined with respect to the rotation axis; and a step of performing printing on the first surface portion to form a pattern portion having a first pattern portion having first light reflectivity and a second pattern portion having second light reflectivity.

### BRIEF DESCRIPTION OF THE DRAWINGS

FIG. 1 is an exploded perspective view of a digital camera.

FIG. 2 is a side view of the digital camera.

FIG. 3 is a main-part cross-sectional view of a lens barrel.

FIG. 4 is a perspective view of an electric zoom mechanism.

FIG. 5 is a main-part cross-sectional view of the lens barrel taken along a circumferential direction.

FIG. 6 is a circuit diagram showing an example of a sensor for detecting a rotation position and a rotation direction of an operation ring.

FIG. 7 is a perspective view of the operation ring and the sensor.

FIG. 8 is a main-part cross-sectional view of a ring member taken along a rotation axis direction.

FIG. 9 is an enlarged perspective view of a part of the ring member.

FIG. 10 is a main-part cross-sectional view showing a disposition of a pattern formed on the operation ring.

FIG. 11 is a block diagram showing a schematic configuration of the digital camera.

FIG. 12 is a flowchart showing steps of manufacturing the operation ring.

FIG. 13 is a perspective view of the ring member before printing a pattern portion.

FIG. 14 is a perspective view showing configurations of a pad and a pad plate.

FIG. 15 is an explanatory view showing a step of transferring the pattern from the pad plate to the pad.

FIG. 16 is an explanatory view showing a state in which the pad is separated from the pad plate and paint is transferred to an outer peripheral surface of the pad.

FIG. 17 is an explanatory view showing a step of pressing the pad against an inner peripheral surface of the ring member to print the pattern portion.

FIG. 18 is an explanatory view showing a state in which the pad is pressed against the inner peripheral surface of the ring member.

FIG. 19 is a main-part cross-sectional view of an operation ring according to a second embodiment.

FIG. 20 is a main-part cross-sectional view of an operation ring according to a third embodiment.

FIG. 21 is a main-part cross-sectional view of an operation ring according to a fourth embodiment.

### DESCRIPTION OF THE PREFERRED EMBODIMENTS

### First Embodiment

### [Configuration of Digital Camera]

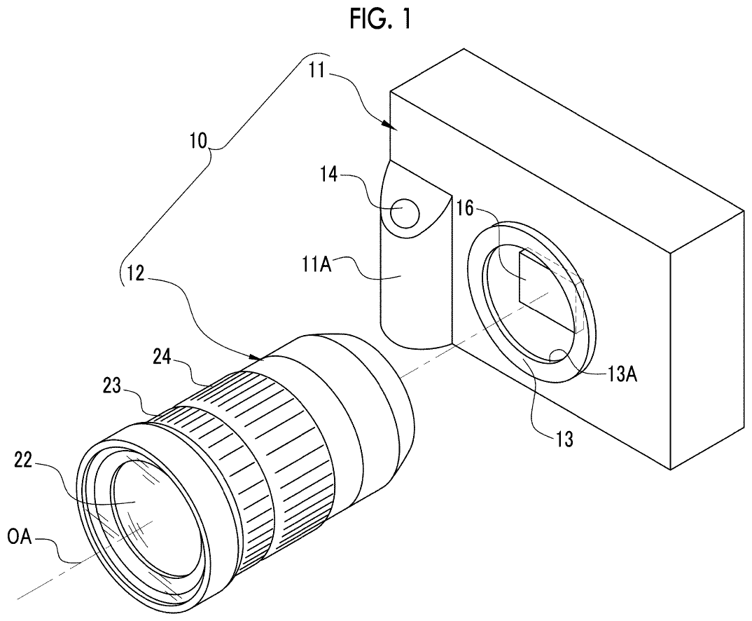

As shown in FIG. 1, a digital camera 10 comprises a camera body 11 and an interchangeable lens barrel 12. A front surface of the camera body 11 is provided with a lens mount 13, a release switch 14, a power switch (not shown), and the like. The lens mount 13 has a circular imaging aperture 13A. The lens barrel 12 is attachably and detachably mounted on the lens mount 13. The lens barrel 12 is an example of a lens device according to the embodiment of the present invention.

The camera body 11 has an imaging element 16 built therein. The imaging element 16 is a complementary metal-oxide-semiconductor (CMOS) image sensor, a charge-coupled device (CCD) image sensor, or an organic thin-film imaging element. The lens mount 13 is provided with a body-side signal contact 17 (see FIG. 13) inside the imaging aperture 13A for electrically connecting to and communicating with the lens barrel 12. The camera body 11 has a grip portion 11A.

### [Configuration of Lens Device]

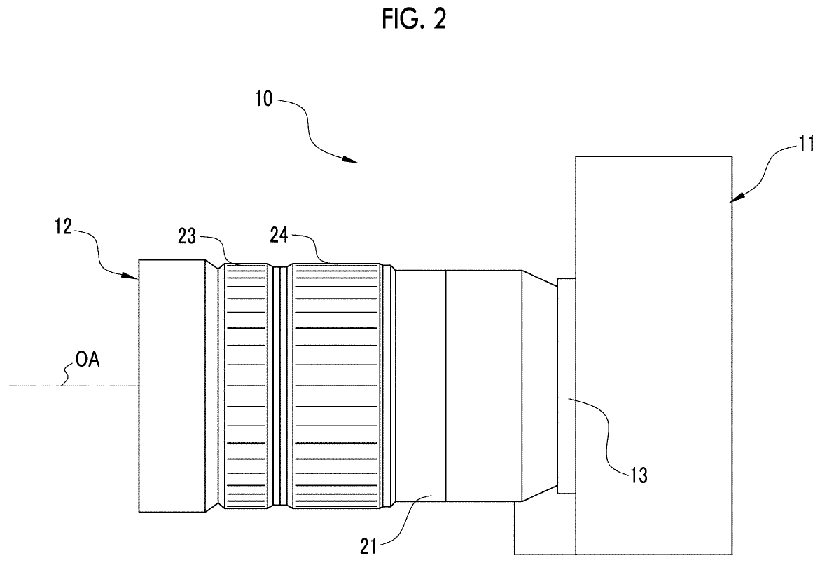

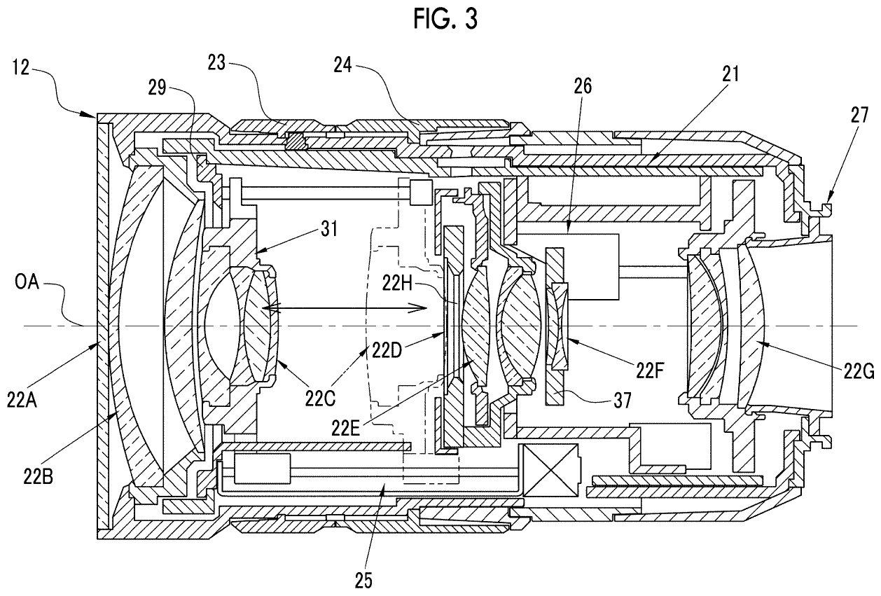

As shown in FIG. 2, the lens barrel 12 comprises a lens barrel body 21, an imaging optical system 22, a zoom ring 23, a focus ring 24, an electric zoom mechanism 25 (see FIG. 3), and a focus mechanism 26 (see FIG. 3). The zoom ring 23 corresponds to an operation ring in the claims.

The lens barrel body 21 has a cylindrical shape, holds the imaging optical system 22, the zoom ring 23, the focus ring 24, the electric zoom mechanism 25, and the focus mechanism 26 inside, and is provided with a lens mount 27 (see FIGS. 3 and 13) and a lens-side signal contact 28 (see FIG. 13) at a rear end thereof. The imaging optical system 22 forms an image of subject light on the imaging element 16 in a case in which the lens barrel 12 is mounted on the camera body 11.

The imaging optical system 22 comprises a filter 22A, a first lens group 22B, a second lens group 22C, a stop 22D, a third lens group 22E, a fourth lens group 22F, and a fifth lens group 22G which are disposed in this order from the subject side toward the imaging element side along an optical axis OA.

Among the first lens group 22B, the second lens group 22C, the third lens group 22E, the fourth lens group 22F, and the fifth lens group, the first lens group 22B has a largest outer diameter. The filter 22A is an optical filter such as a polarizing filter or a filter for light amount adjustment. The filter 22A has a maximum outer diameter portion larger than a maximum outer diameter portion of the first lens group 22B. The filter 22A and the first lens group 22B are fixed to a distal end part of the lens barrel body 21.

The second lens group 22C corresponds to a zoom lens in the claims. In the lens barrel 12, the second lens group 22C is moved along the optical axis OA to change magnification. The second lens group 22C is moved by using the electric zoom mechanism 25. The electric zoom mechanism 25 drives the second lens group 22C in accordance with the rotation of the zoom ring 23. The second lens group 22C is moved between a wide angle side position (position indicated by a solid line in FIG. 3) and a telephoto side position (position indicated by a two-dot chain line).

The stop 22D is a fixed stop in which an open F number is fixed, and a stop aperture 22H is formed at the center of a thin plate member. The stop 22D is fixed to the inside of the lens barrel body 21. It should be noted that the stop 22D is not limited to this, and may be a variable stop composed of a stop mechanism that varies the open F number. The third lens group 22E is a relay lens group fixed to the inside of the lens barrel body 21.

The fourth lens group 22F is a focus lens. In the lens barrel 12, the focus is adjusted by moving the fourth lens group 22F in a direction of the optical axis OA. The fourth lens group 22F is moved by using the focus mechanism 26. The focus mechanism 26 drives the fourth lens group 22F in accordance with the rotation of the focus ring 24. The fifth lens group 22G is a relay lens group fixed to the rear end portion of the lens barrel body 21. The fifth lens group 22G forms, on the imaging element, an image of a real image transmitted through the filter 22A, the first lens group 22B, the second lens group 22C, the stop 22D, the third lens group 22E, and the fourth lens group 22F.

The electric zoom mechanism 25 is disposed inside the lens barrel 12. The electric zoom mechanism 25 drives the second lens group 22C that is a part of the imaging optical system 22. The electric zoom mechanism 25 is attached to the lens barrel body 21 via an attachment member 29 and the like. As described above, the second lens group 22C is located between the first lens group 22B and the stop 22D and is located on a subject side with respect to the stop 22D. That is, the second lens group 22C can move between the first lens group 22B and the stop 22D.

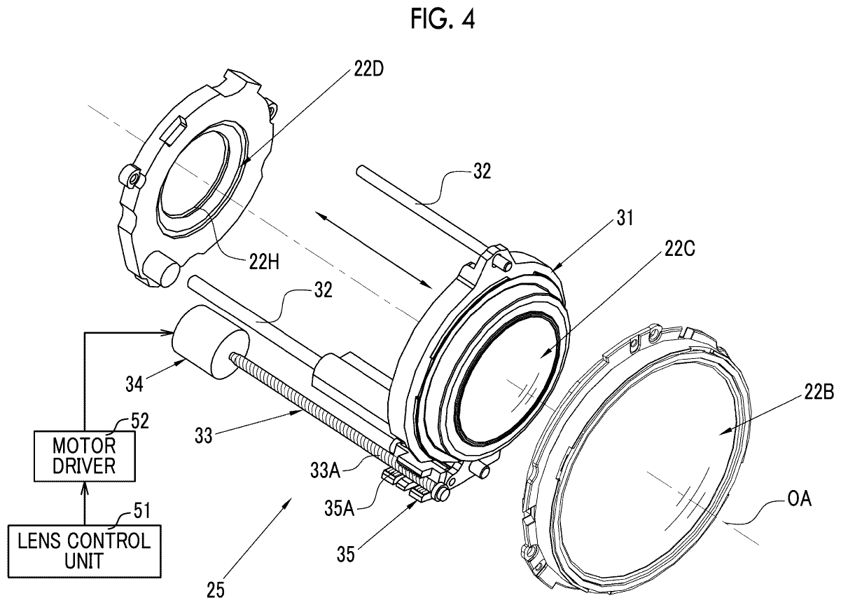

As shown in FIG. 4, the second lens group 22C is held by a lens holding frame 31. The lens holding frame 31 is connected to a zoom carriage 35 described later. The electric zoom mechanism 25 comprises two guide shafts 32, a lead screw 33, a motor 34, and the zoom carriage 35. A lens control unit 51 controls the energization of the motor 34 via a motor driver 52. As will be described later, the lens control unit 51 controls the respective units of the lens barrel 12.

The guide shaft 32 is a cylindrical shaft made of metal or resin. A distal end and a base end of the guide shaft 32 are directly attached to the lens barrel body 21, or are attached to the lens barrel body 21 via the attachment member 29. The lens holding frame 31 is attached to the guide shaft 32 to be movable in the direction of the optical axis OA.

The lead screw 33 is a substantially cylindrical axis made of metal or resin and having a screw 33A on an outer periphery thereof. The lead screw 33 is connected to a rotation shaft of the motor 34 and is rotationally moved in both directions by using the motor 34. The motor 34 is, for example, a stepping motor.

The zoom carriage 35 is connected to the lens holding frame 31 and moves along the guide shaft 32, that is, in the direction of the optical axis OA along with the second lens group 22C and the lens holding frame 31. A rack gear 35A is formed on a surface of the zoom carriage 35 facing the lead screw 33. The zoom carriage 35 is biased to a screw 33A of the lead screw 33 by using a spring member (not shown). The rack gear 35A meshes with the screw 33A. Therefore, the rotation of the lead screw 33 is converted into a linear movement by the screw 33A and the rack gear 35A, and the second lens group 22C is moved along the direction of the optical axis OA along with the lens holding frame 31.

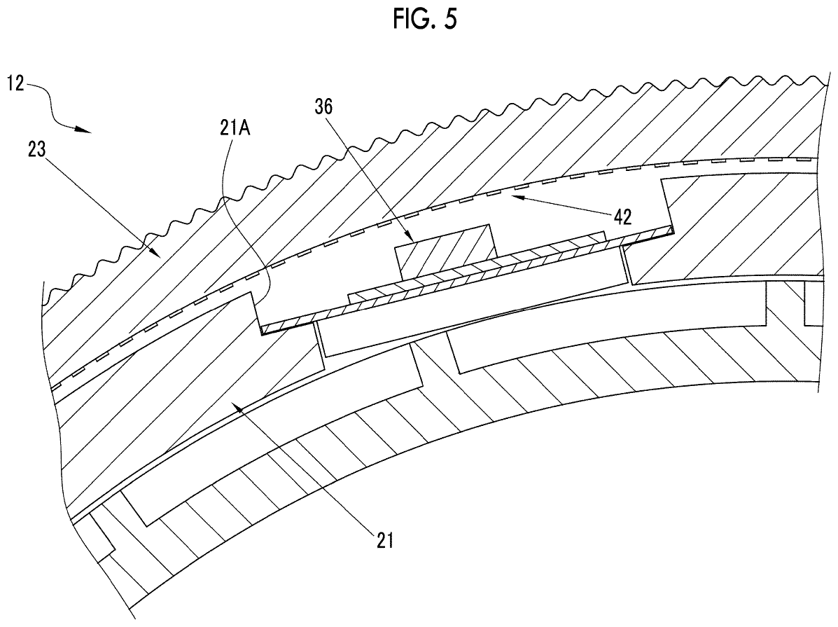

The lens control unit 51 detects a rotation position of the zoom ring 23 via a sensor 36 (see FIGS. 5 to 7 and 13), and moves the second lens group 22C in accordance with information on a rotation direction and the rotation position. The sensor 36 is a sensor capable of performing detection with a high resolution, and for example, a photoreflector is used.

The focus mechanism 26 is composed of a voice coil motor (hereinafter, referred to as a VCM), and comprises a magnetic circuit and a coil (which are not shown). The fourth lens group 22F is held by a lens holding frame 37. The magnetic circuit or the coil is connected to the lens holding frame 37. In the focus mechanism 26, the lens holding frame 37 and the fourth lens group 22F are driven by using a magnetic force generated by energizing the coil.

The lens control unit 51 detects a rotation position of the focus ring 24 via a sensor 38 (see FIG. 13), and moves the fourth lens group 22F in accordance with information on a rotation direction and a rotation amount. It should be noted that the configuration of the focus mechanism 26 is not limited to this, and the focus mechanism 26 may comprise a lead screw, a motor, and the like as in a case of the electric zoom mechanism 25, and may convert the rotation of the lead screw into a linear movement to move the fourth lens group 22F in the direction of the optical axis OA.

### [Configuration of Sensor]

As shown in FIG. 5, the sensor 36 is attached to an opening portion 21A formed in the lens barrel body 21. The sensor 36 is disposed at a position facing an inner peripheral surface of the zoom ring 23. A pattern portion 42, which will be described later, is formed on the inner peripheral surface of the zoom ring 23, a signal based on the pattern portion 42 is obtained by the sensor 36, and thus the rotation direction and the rotation position of the zoom ring 23 can be detected.

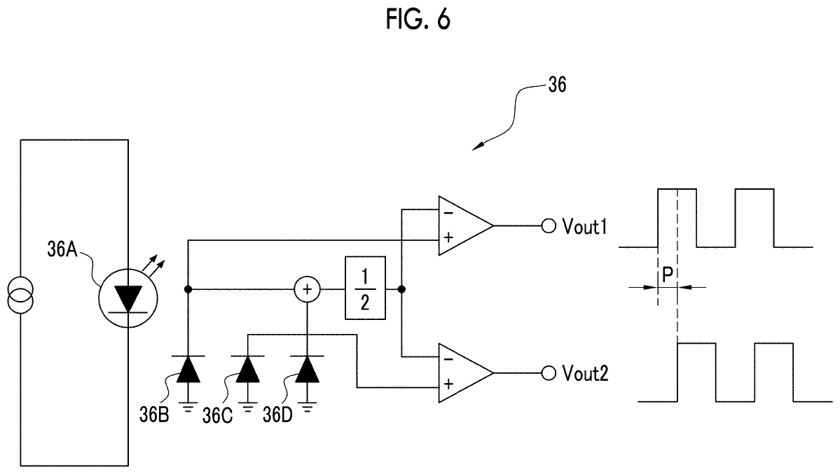

FIG. 6 shows an example of a circuit constituting the sensor 36. In the example shown in FIG. 5, the sensor 36 comprises a light-emitting diode (LED) 36A and three light-receiving integrated circuits (ICs) 36B, 36C, and 36D on a substrate. The sensor 36 is disposed such that a phase difference between output signals is generated by 90° in an order of the light-receiving ICs 36B, 36C, and 36D.

By emitting light and receiving light with respect to a pattern portion having a first pattern portion having first light reflectivity and a second pattern portion having second light reflectivity by using the sensor 36 having the above-described configuration, it is possible to output digital two-phase signals Vout1 and Vout2 in which a phase Pis deviated by 90°. The rotation direction and the rotation position can be detected by using these two-phase signals Vout1 and Vout2. Further, by detecting the rising/falling of the two-phase signals Vout1 and Vout2 of the sensor 36, a resolution of ¼ of a pattern period is obtained. It should be noted that the first light reflectivity is higher than the second light reflectivity.

### [Configuration of Operation Ring]

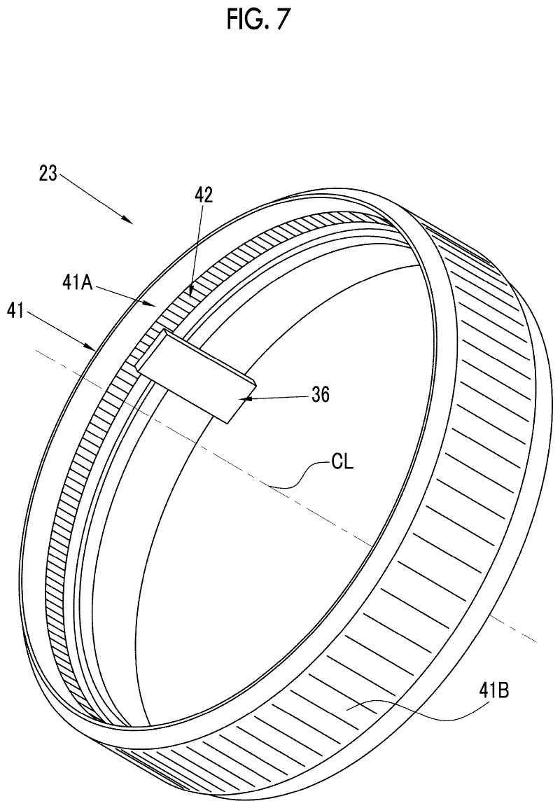

As shown in FIG. 7, the zoom ring 23 comprises a ring member 41 and a pattern portion 42. The pattern portion 42 is formed on an inner peripheral surface 41A of the ring member 41 and serves as an indicator of a rotation operation of the ring member 41. The ring member 41 includes a resin member, and a material thereof is, for example, a carbon fiber composite material or a polycarbonate reinforced resin. The ring member 41 is formed in an annular shape, and a knurl is formed on an outer peripheral surface 41B.

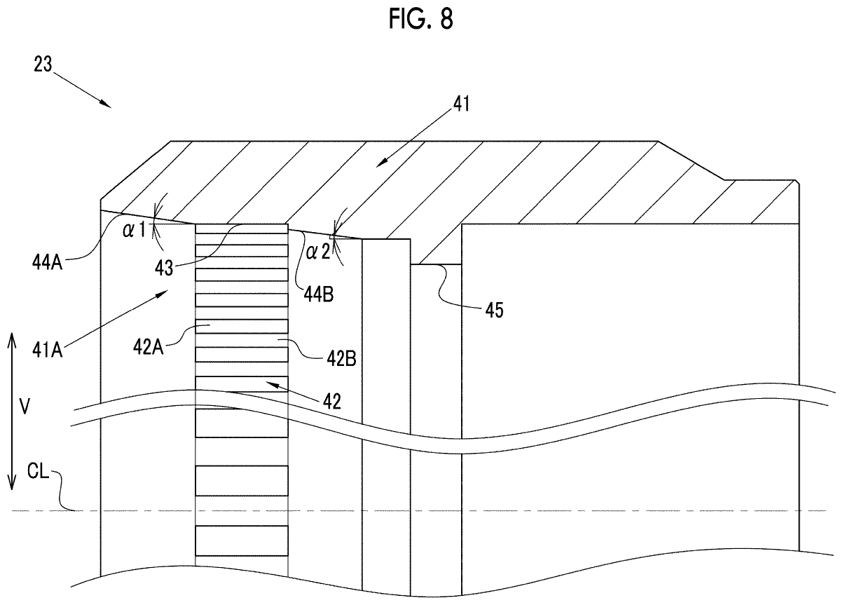

As shown in FIG. 8, the inner peripheral surface 41A of the ring member 41 has a first surface portion 43, second surface portions 44A and 44B, and a flange portion 45. The first surface portion 43 is parallel to a rotation axis CL of the ring member 41. It should be noted that, in a case in which the ring member 41 is incorporated by being externally fitted to the lens barrel body 21, the rotation axis CL matches the optical axis OA of the imaging optical system 22. It should be noted that the term “parallel” described in the present specification may include an error to the extent that there is no problem in design or manufacturing.

The second surface portions 44A and 44B are inclined with respect to the rotation axis CL. The second surface portion 44A is located on one end side in the rotation axis CL direction, and the second surface portion 44B is located on the other end side thereof. The second surface portion 44A corresponds to an one-end-side second surface portion in the claims, and the second surface portion 44B corresponds to an other-end-side second surface portion in the claims. It should be noted that, in the present embodiment, in a case in which the ring member 41 is incorporated in the lens barrel body 21, the one end side indicates the subject side, and the other end side indicates the imaging element side.

The first surface portion 43 is located between the second surface portion 44A and the second surface portion 44B in the rotation axis CL direction. A first inclination angle α1 at which the second surface portion 44A is inclined with respect to the rotation axis CL direction is larger than a second inclination angle α2 at which the second surface portion 44B is inclined with respect to the rotation axis CL direction. Therefore, in a case of pad printing described later, the pad is easily inserted into the ring member 41.

In the ring member 41, the printing is performed on the first surface portion 43 to form the pattern portion 42, and specifically, the pattern portion 42 has a first pattern portion 42A and a second pattern portion 42B. The first pattern portion 42A is formed by being coated with paint. The paint forming the first pattern portion 42A contains a metal material, and a mixing ratio of the metal material in the paint is 25% or more and 45% or less. The paint used for forming the first pattern portion 42A is, for example, an aluminum paste diluted with an organic solvent as the metal material. The aluminum paste is a metal pigment containing aluminum particles.

As described above, the mixing ratio of the metal material in the paint is set to 25% or more and 45% or less because a proportion of the metal material is decreased and the light reflectivity is insufficient in a case in which the mixing ratio of the metal material is less than 25%, and the proportion of the organic solvent is decreased and the adhesion strength to the ring member 41 is decreased in a case in which the mixing ratio of the metal material exceeds 40%.

The first pattern portion 42A has first light reflectivity because the paint containing the metal material is printed as described above. The second pattern portion 42B is a portion of the ring member 41 on which the printing is not performed, and the ring member 41 includes the resin member as described above. Therefore, the second pattern portion 42B has second light reflectivity different from the first light reflectivity. Since the metal material has gloss higher than gloss of the resin material, the first light reflectivity is higher than the second light reflectivity. That is, in the pattern portion 42, the first pattern portion 42A having the first light reflectivity and the second pattern portion 42B having the second light reflectivity are alternately disposed. As described above, it is possible to detect the rotation direction and the rotation amount of the zoom ring 23 by combining the pattern portion 42 and the sensor 36.

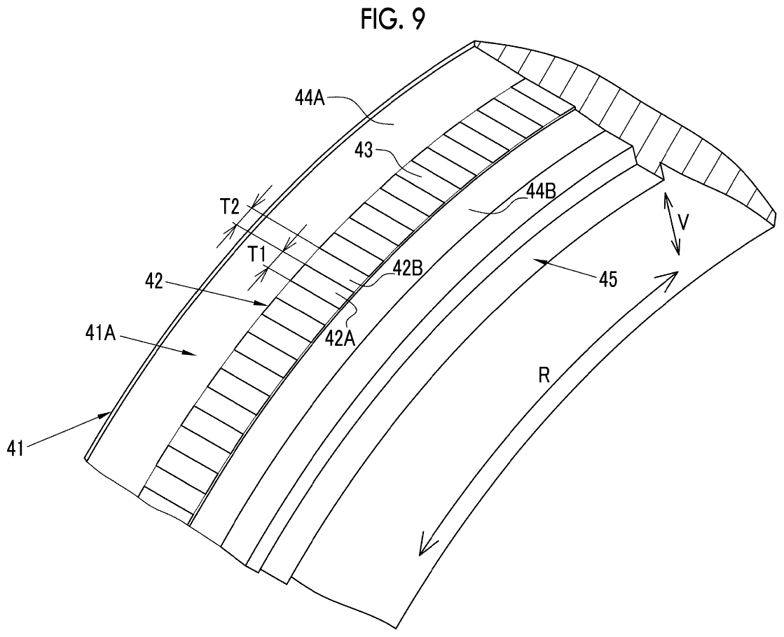

As shown in FIG. 9, in the pattern portion 42, the first pattern portion 42A and the second pattern portion 42B are disposed at equal intervals in a circumferential direction R of the zoom ring 23. That is, a width T1 of the first pattern portion 42A and a width T2 of the second pattern portion 42B in the circumferential direction R have the same dimension. It should be noted that it is preferable that the widths T1 and T2 are set to an interval of 0.2 mm or more and 0.3 mm or less. In this way, the rotation position of the zoom ring 23 can be detected with a high resolution by forming the fine pattern portion 42.

In the operation ring in the related art, since the inner peripheral surface has a draft angle, a pattern for detection via a sensor is formed on a surface inclined with respect to the rotation axis. In a case in which the pattern is formed on the surface inclined with respect to the rotation axis, an inner diameter of the operation ring is different at different positions with respect to the central axis direction, so that the pattern cannot be accurately formed on such a surface.

On the other hand, in the zoom ring 23 according to the present embodiment, since the first surface portion 43 parallel to the rotation axis CL and the second surface portions 44A and 44B inclined with respect to the rotation axis CL are provided, and the pattern portion 42 is formed by printing on the first surface portion 43, the pattern portion 42 can be formed with high accuracy while ensuring a draft angle that is separated from a mold. It should be noted that a manufacturing method of printing the pattern portion 42 will be described later.

The flange portion 45 is located inside the first surface portion 43 in a radial direction V of the ring member 41. Furthermore, the second surface portion 44A and the second surface portion 44B are located outside the flange portion 45 in the radial direction V. It should be noted that the radial direction V here is a radial direction of the ring member 41, and in a case in which the zoom ring 23 is incorporated in the lens barrel body 21, the radial direction Vis a direction orthogonal to the rotation axis CL and the optical axis OA, and the same applies hereinafter. In addition, the flange portion 45 corresponds to a stepped portion in the claims.

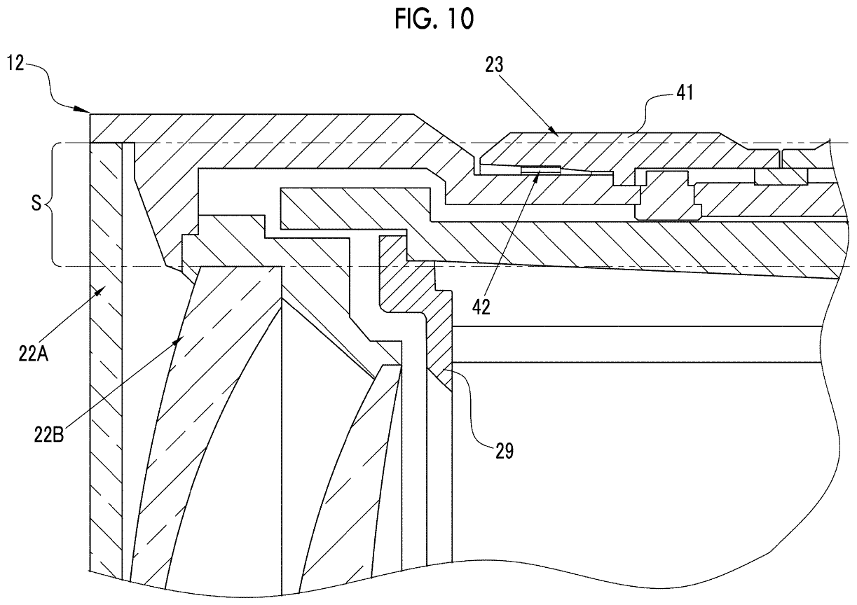

As shown in FIG. 10, the pattern portion 42 is located between the maximum outer diameter portion of the first lens group 22B and the maximum outer diameter portion of the filter 22A. The reference numeral S denotes a space between the maximum outer diameter portion of the first lens group 22B and the maximum outer diameter portion of the filter 22A, and the pattern portion 42 is disposed in the space S. As described above, the second lens group 22C and the electric zoom mechanism 25 that drives the second lens group 22C are disposed on the base end side (imaging element side) of the first lens group 22B, and thus a space for disposing the components is small. Therefore, the pattern portion 42 is disposed at a position at which the pattern portion 42 does not interfere with the second lens group 22C, the electric zoom mechanism 25, and the like, and thus the efficiency of component disposition is improved. The filter 22A has the maximum outer diameter portion larger than the maximum outer diameter portion of the first lens group 22B, and is located on the subject side with respect to the first lens group 22B. That is, the space S has a relatively sufficient space for component disposition in the lens barrel 12. By disposing the pattern portion 42 in such a space S, the efficiency of component disposition is improved, and the size reduction of the lens barrel 12, particularly the reduction of the outer diameter thereof, can be achieved.

### [Electric Configuration of Digital Camera]

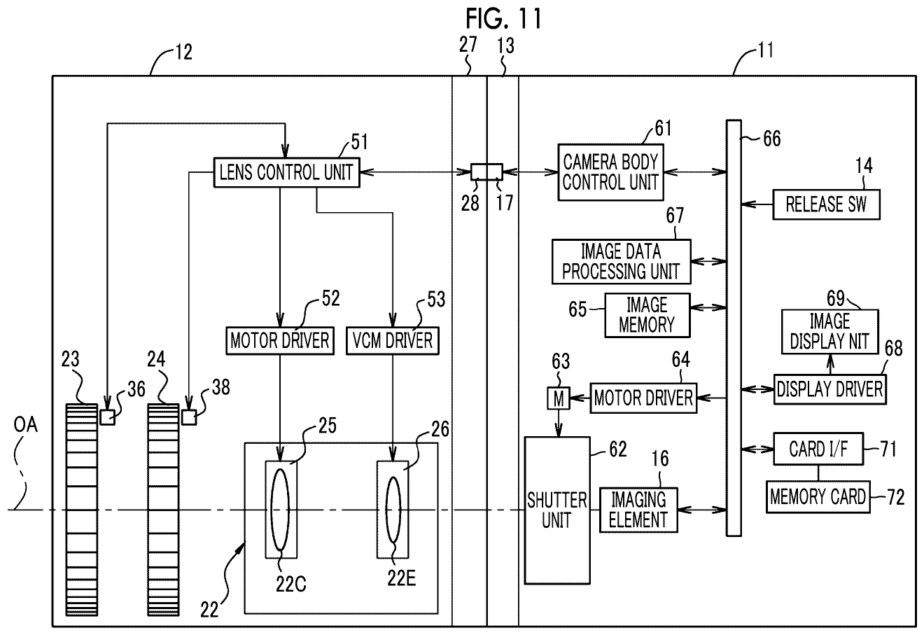

As shown in FIG. 11, the lens barrel 12 comprises the imaging optical system 22, the zoom ring 23, the focus ring 24, the electric zoom mechanism 25, the focus mechanism 26, the sensor 36, the sensor 38, the lens control unit 51, the motor driver 52, a VCM driver 53, and the like.

The lens control unit 51 consists of a microcomputer comprising a CPU, a read-only memory (ROM) that stores programs or parameters used in the CPU, a random access memory (RAM) used as a work memory of the CPU (none of which is shown), and controls the respective units of the lens barrel 12. The motor driver 52, the VCM driver 53, the sensor 36, and the sensor 38 are connected to the lens control unit 51.

The lens control unit 51 controls the drive of the second lens group 22C based on a control signal from the camera body control unit 61, which will be described later. The lens control unit 51 detects the rotation position of the zoom ring 23 via the sensor 36, and moves the second lens group 22C in accordance with the information on the rotation direction and the rotation amount.

As described above, although the imaging optical system 22 comprises a plurality of lens groups including the second lens group 22C and the fourth lens group 22F, in FIG. 13, in order to prevent the drawings from becoming complicated, the lens groups other than the second lens group 22C and the fourth lens group 22F are omitted. The second lens group 22C is moved in the direction of the optical axis OA by energizing the motor 34 constituting the electric zoom mechanism 25 from the motor driver 52, and varies an angle of view of the imaging optical system 22. The lens control unit 51 transmits the control signal for moving the second lens group 22C to the motor driver 52 in accordance with the information on the rotation direction and the rotation amount of the zoom ring 23. The motor driver 52 energizes the motor 34 based on the control signal.

The fourth lens group 22F is moved in the direction of the optical axis OA by energizing the coil constituting the focus mechanism 26 from the VCM driver 53, and adjusts the focus of the imaging optical system 22. The lens control unit 51 transmits the control signal for moving the fourth lens group 22F to the VCM driver 53 in accordance with the information on the rotation direction and the rotation amount of the focus ring 24. The VCM driver 53 energizes the coil based on the control signal.

The camera body control unit 61 comprises a CPU, a ROM that stores programs or parameters used in the CPU, and a RAM used as a work memory of the CPU (none of which is shown). The camera body control unit 61 controls the camera body 11 and the respective units of the lens barrel 12 connected to the camera body 11. A release signal is input to the camera body control unit 61 from the release switch 14. The body-side signal contact 17 is connected to the camera body control unit 61.

The lens-side signal contact 28 is in contact with the body-side signal contact 17 in a case in which the lens mount 27 of the lens barrel 12 is mounted on the lens mount 13 of the camera body 11, and the lens barrel 12 and the camera body 11 are electrically connected to each other.

A shutter unit 62 is a so-called focal plane shutter, and is disposed between the lens mount 13 and the imaging element 16. The shutter unit 62 is provided to be capable of blocking an optical path between the imaging optical system 22 and the imaging element 16, and is changed between an open state and a closed state. The shutter unit 62 is put into the open state in a case of capturing a live view image and a moving image. In a case of capturing a still image, the shutter unit 62 is temporarily put into the closed state from the open state. The shutter unit 62 is driven by a shutter motor 63. A motor driver 64 controls the driving of the shutter motor 63.

The imaging element 16 is driven and controlled by the camera body control unit 61. The imaging element 16 has a light-receiving surface composed of a plurality of pixels (not shown) arranged in a two-dimensional matrix. Each pixel includes a photoelectric conversion element, and performs photoelectric conversion of a subject image formed on the light-receiving surface via the imaging optical system 22 to generate an imaging signal.

The imaging element 16 comprises signal processing circuits, such as a noise removal circuit, an auto gain controller, and an A/D conversion circuit (none of which is shown). The noise removal circuit performs noise removal processing on the imaging signal. The auto gain controller amplifies a level of the imaging signal to an optimal value. The A/D conversion circuit converts the imaging signal into a digital signal and outputs the converted signal from the imaging element 16 to a busline 66. The output signal of the imaging element 16 is image data (so-called RAW data) having one color signal for each pixel.

An image memory 65 stores image data for one frame output to the busline 66. An image data processing unit 67 reads out the image data for one frame from the image memory 65 and performs known image processing, such as matrix operation, demosaicing processing, y correction, brightness/color difference conversion, and resizing processing.

The display driver 68 sequentially inputs the image data for one frame, which is image-processed by the image data processing unit 67, to the image display unit 69. The image display unit 69 is provided, for example, on a rear surface of the camera body 11 and sequentially displays the live view images at regular intervals. A card interface (I/F) 71 is incorporated in a card slot (not shown) provided in the camera body 11 and is electrically connected to a memory card 72 inserted in the card slot. The card I/F 71 stores the image data subjected to the image processing by the image data processing unit 67 in the memory card 72. In a case in which the image data stored in the memory card 72 is reproduced and displayed, the card I/F 71 reads out the image data from the memory card 72.

### [Step of Manufacturing Operation Ring]

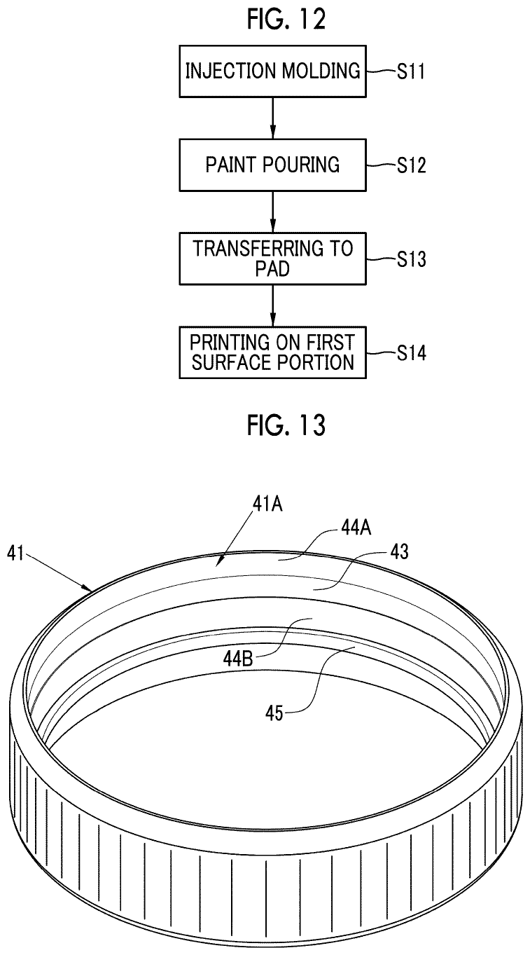

Hereinafter, steps of manufacturing the zoom ring 23 will be described with reference to the flowchart shown in FIG. 12 and the explanatory views shown in FIGS. 13 to 18. As shown in FIGS. 12 and 13, first, a step of forming the ring member 41 via an injection molding step is performed (S11). As described so far, the ring member 41 has the first surface portion 43 parallel to the rotation axis CL of the ring member 41. In principle, a surface parallel to the axial direction, such as the first surface portion 43, is not suitable for forming via the injection molding. This is because, in a case in which the mold is separated from an injection-molded product in the axial direction after the injection molding step, a so-called undercut state is established, and the surface parallel to the axial direction serves as a resistance to hinder the movement of the mold. Therefore, in the method of manufacturing the operation ring in the related art, for example, a slide mold that can be moved in the radial direction with respect to the main mold is used, but, in this case, the structure of the mold becomes complicated, and the cost increases. Alternatively, in a case in which all of the inner peripheral surfaces of the ring member are inclined with respect to the rotation axis, an increase in cost of the injection molding is suppressed, but the accuracy of printing the pattern portion 42 is reduced.

On the other hand, in the present embodiment, since the ring member 41 has the second surface portions 44A and 44B that are inclined with respect to the rotation axis CL, together with the first surface portion 43, the portions of the second surface portions 44A and 44B are the draft angles. That is, in a case in which the mold is separated from the ring member 41 in the axial direction after the injection molding step, the first surface portion 43 has resistance to the mold and requires a pulling force for moving the mold, but the mold can be separated because the portions of the second surface portions 44A and 44B are the draft angles. Accordingly, in a case in which the ring member 41 is formed in the injection molding step, the mold can be moved by a general tensile force in a case in which the mold is separated from the injection molded product. Therefore, the slide mold is not necessary.

Before the pattern portion 42 is formed, the printing is not performed on the first surface portion 43 in a state in which the ring member 41 is formed of a resin material by the injection molding step or the like. In the present embodiment, the printing of forming the pattern portion 42 is pad printing. The pad printing is also called pad printing.

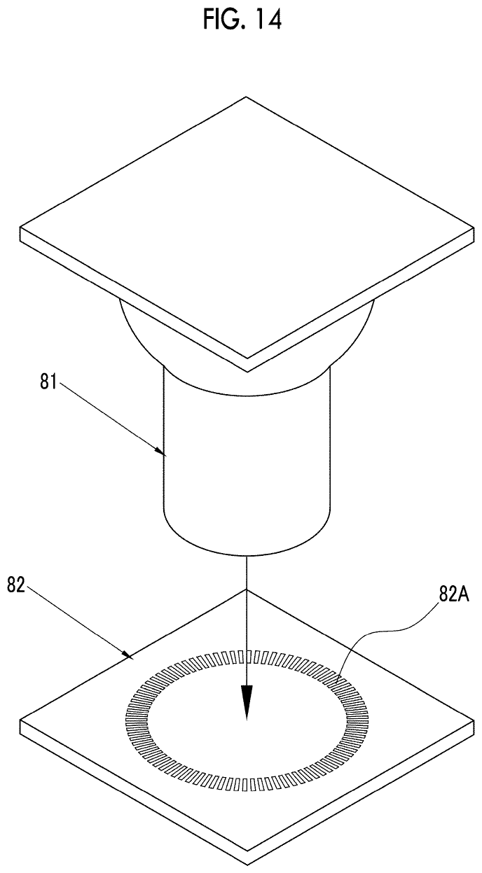

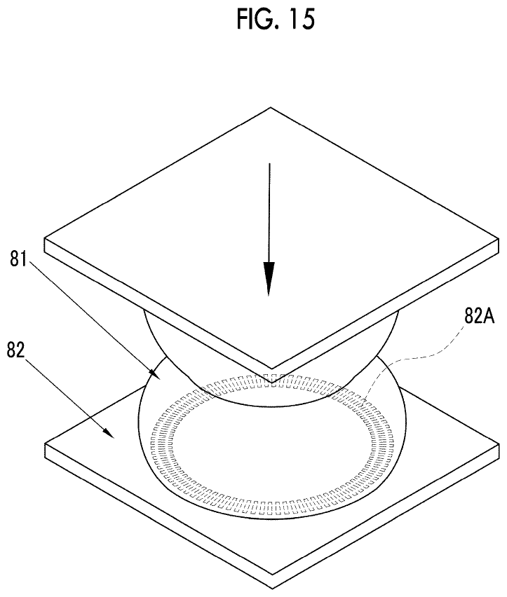

As shown in FIG. 14, a step of pouring the paint into the pad plate 82 is performed as a step before forming the pattern portion 42 (S12). The pad plate 82 is formed with a recess portion 82A corresponding to the pattern portion 42, and the recess portion 82A is a recess portion formed on one surface of the pad plate 82 by etching, laser irradiation, and the like. The paint protruding from the recess portion 82A is removed by scraping the surface of the pad plate 82 with a spatula or the like. That is, only the paint entering the recess portion 82A is transferred to the pad 81.

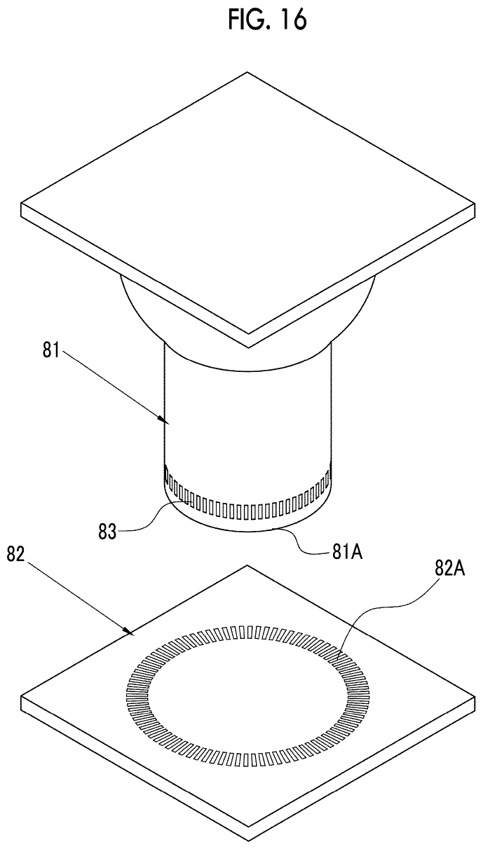

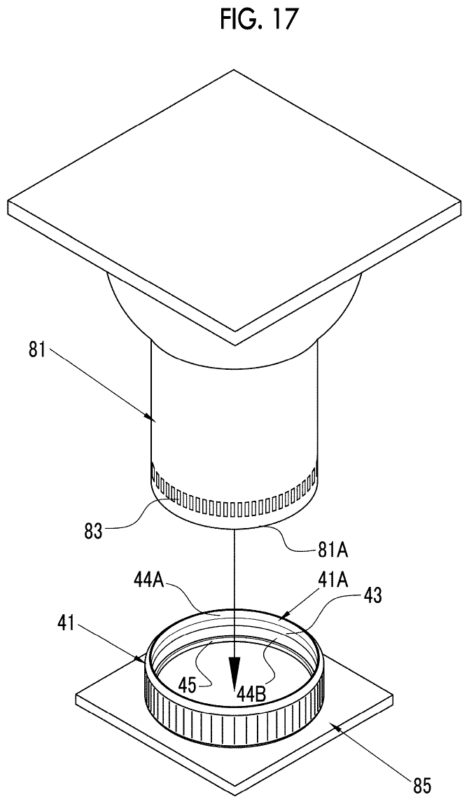

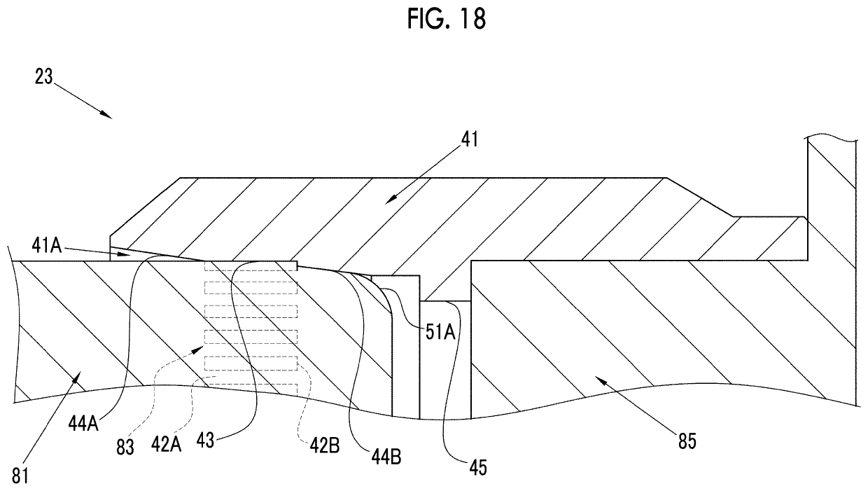

As described above, since the pattern portion 42 of the zoom ring 23 is printed on the first surface portion 43 parallel to the rotation axis CL, which is the inner peripheral surface 41A of the ring member 41, in a pattern 83 (see FIGS. 16 and 17), the paint should adhere at a position facing the first surface portion 43, that is, the outer peripheral surface of the pad 81. The patterns 83 in a state of being transferred to the pad 81 are arranged in the circumferential direction of the pad 81 and disposed along the axial direction. In order to transfer such a pattern 83, the recess portion 82A is composed of a plurality of grooves disposed radially.

As shown in FIG. 15, a step of transferring the paint entering the recess portion 82A to the pad 81 is performed by pressing the pad 81 against the pad plate 82 (S13). Since the material of the pad 81 is silicon, the pad 81 is pressed against the pad plate 82 and is crushed. The pad 81 is pressed against the pad plate 82 up to a portion that is the outer peripheral surface of the pad 81 in a state in which the pad 81 is crushed, and the paint adheres to the pad plate 82. As shown in FIG. 16, in a case in which the pad 81 is separated from the pad plate 82, the pad 81 returns to the original state from the crushed state. As a result, the paint is transferred to the outer peripheral surface of the pad 81.

In addition, as described above, since the material of the pad 81 is silicon, a corner portion 81A has a rounded shape (curved shape). As a result, the pattern 83 in a state of being transferred to the pad 81 is transferred from the corner portion 81A at a certain interval.

As shown in FIG. 17, a step of pressing the pad 81 against the inner peripheral surface of the ring member 41 and printing the pattern portion 42 on the first surface portion 43 is performed (S14). That is, the printing is performed on the first surface portion 43, and to form the pattern portion 42 having the first pattern portion 42A having the first light reflectivity and the second pattern portion 42B having the second light reflectivity. In a case in which this step is performed, the position of the ring member 41 in the axial direction and the radial direction is fixed by a jig 85, and the pad 81 is pressed in a state in which the central axis of the pad 81 and the rotation axis CL of the ring member 41 match each other.

As shown in FIG. 18, since the first surface portion 43 is the surface parallel to the rotation axis CL, the outer peripheral surface of the pad 81 faces the first surface portion 43 and is pressed against the first surface portion 43 with an equal force. The outer peripheral surface of the pad 81 is smoothly inserted along the first surface portion 43. As a result, the paint adhering to the outer peripheral surface of the pad 81 is precisely transferred to the first surface portion 43, to form the first pattern portion 42A. In addition, the jig 85 comes into contact with the flange portion 45 to position the ring member 41 in the axial direction and the radial direction.

In addition, since the pattern 83 in a state of being transferred to the pad 81 is transferred from the corner portion 81A of the pad 81 at a certain interval, in a case in which the flange portion 45 and the first surface portion 43 are in contact with each other, the paint of the pattern 83 does not reach the first surface portion 43. However, in the present embodiment, as described above, the first surface portion 43 is located between the second surface portions 44A and 44B, and the second surface portion 44B is located on a back side (the other end side) of the first surface portion 43. Accordingly, since the pad 81 can be inserted to the back side (the other end side) of the first surface portion 43 on which the printing is performed, the paint of the pattern 83 can reach the first surface portion 43, and the printing can be performed. [Operation of Lens Device]

The operation of the lens barrel 12 according to the present embodiment will be described. In a case in which the lens barrel 12 is mounted on the camera body 11 and the power switch (not shown) is operated by a user as a person who captures an image, the power is supplied to each unit of the digital camera 10.

In a state in which the power of the digital camera 10 is turned on, the imaging element 16, the camera body control unit 61, the lens control unit 51, and the like are activated. As described above, the rotation position of the zoom ring 23 is detected by the sensor 36, and the lens control unit 51 moves the second lens group 22C in accordance with the information on the rotation direction and the rotation position.

As described above, in the zoom ring 23, since the pattern portion 42 is printed on the first surface portion 43, which is the surface parallel to the rotation axis CL, the paint adhering to the outer peripheral surface of the pad 81 is precisely transferred to the first surface portion 43. Therefore, the accuracy of printing the pattern portion 42 can be improved, and the pattern portion 42 having the fine first pattern portion 42A and the fine second pattern portion 42B can be formed. Therefore, in a case in which the zoom ring 23 is rotated, the sensor 36 can detect the rotation position of the zoom ring 23 with a high resolution.

For example, in a case in which the widths of the first pattern portion 42A and the second pattern portion 42B constituting the pattern portion 42 are 0.25 mm, that is, the pattern period is 0.5 mm, the sensor 36 emits light and receives light with respect to the pattern portion 42 to obtain the two-phase signals Vout1 and Vout2, and the rotation direction and the rotation position can be detected by the two-phase signals Vout1 and Vout2. Further, as described above, by detecting the rising/falling of the two-phase signals Vout1 and Vout2 of the sensor 36, it is possible to detect a change in the rotation position corresponding to a resolution of ¼ of the pattern period, that is, 0.125 mm.

In addition, since the pattern portion 42 formed on the zoom ring 23 is formed by the printing, the thickness and the outer diameter of the zoom ring 23 can be reduced. Therefore, it is possible to achieve the size reduction of the lens barrel 12 and reduction of the outer diameter thereof.

By forming the pattern portion 42 via the printing, it is not necessary to provide the pattern with a component different from the zoom ring 23, and it is possible to facilitate the assembly step, reduce the number of components, and reduce costs.

In addition, as described above, since the zoom ring 23 has the first surface portion 43, which is the surface parallel to the rotation axis CL, and the second surface portions 44A and 44B, which are inclined with respect to the rotation axis CL, the slide mold is not necessary. Accordingly, it is possible to suppress the increase in cost in the manufacturing step of the zoom ring 23. Further, in a case in which the slide mold is used, unevenness due to the panel line and an error in the curvature radius between the main mold and the slide mold occur, so that the printing accuracy of the pattern portion 42 is reduced, but, in the present embodiment, since the slide mold is not used, such a problem does not occur.

### Second Embodiment

In the first embodiment, the flange portion 45 as the stepped portion is located inside the first surface portion 43 in the radial direction, but the present invention is not limited to this, and, in the following second embodiment, a configuration is described in which the stepped portion is located outside the first surface portion in the radial direction.

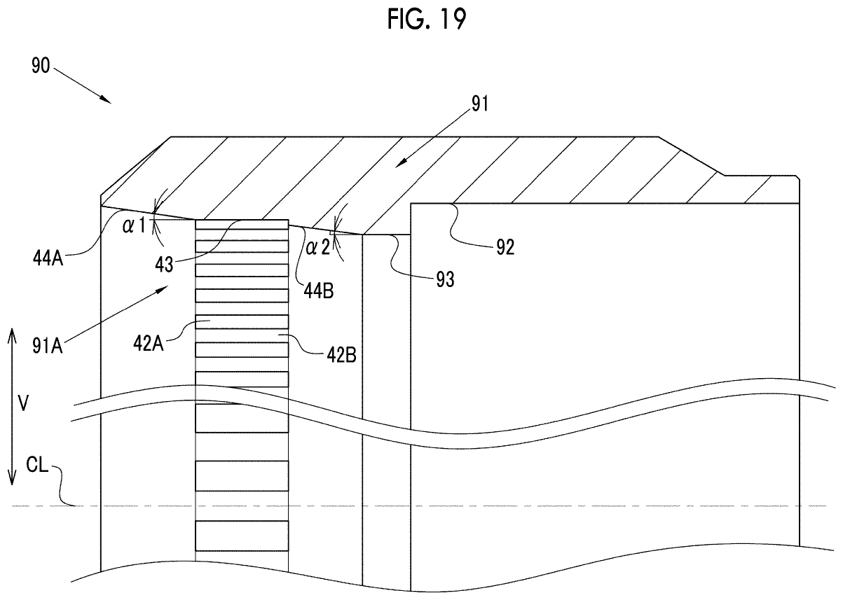

As shown in FIG. 19, the zoom ring 90 according to the present embodiment comprises a ring member 91 and the pattern portion 42. The zoom ring 90 corresponds to an operation ring in the claims. It should be noted that the configuration of the lens device, such as the imaging optical system 22 and the electric zoom mechanism 25, except for the zoom ring 90, is the same as the configuration in the above-described embodiment, and the description thereof will be omitted. The same applies to the pad 81, the pad plate 82, and the like in a case in which the pattern portion 42 is printed on the ring member 91.

The ring member 91 includes a resin member and has the same material as the ring member 41 according to the first embodiment. An inner peripheral surface 91A of the ring member 91 has the first surface portion 43, the second surface portions 44A and 44B, a stepped portion 92, and an innermost diameter portion 93. The first surface portion 43 and the second surface portions 44A and 44B are the same as in the ring member 41 according to the first embodiment, that is, the first surface portion 43 is parallel to the rotation axis CL of the ring member 91, and the second surface portions 44A and 44B are inclined with respect to the rotation axis CL. In addition, the first surface portion 43 is located between the second surface portion 44A and the second surface portion 44B in the rotation axis CL direction, and the first inclination angle α1 at which the second surface portion 44A is inclined with respect to the rotation axis CL direction is larger than the second inclination angle α2 at which the second surface portion 44B is inclined with respect to the rotation axis CL direction.

The pattern portion 42 is formed by the printing on the first surface portion 43, similarly to the zoom ring 23 according to the first embodiment. The pattern portion 42 includes the first pattern portion 42A and the second pattern portion 42B, the configurations of the first pattern portion 42A and the second pattern portion 42B, the configuration of the paint to be applied to the first pattern portion 42A, and the like are also the same as the configurations in the first embodiment.

The stepped portion 92 is located outside the first surface portion 43 in the radial direction V. The ring member 91 has the innermost diameter portion 93 of which the inner diameter of the ring member 91 is minimized, inside the first surface portion 43 in the radial direction V. The second surface portion 44B is disposed at a position continuous to the innermost diameter portion 93.

The step of manufacturing the zoom ring 90 is the same as the step of manufacturing the zoom ring 23 according to the first embodiment, and in the step of printing the pattern portion 42 on the first surface portion 43, the pad printing is performed in the same manner as in the first embodiment. In a case in which the pattern 83 is transferred from the pad 81, the jig is fitted to the stepped portion 92 to perform the registration. In a case in which the stepped portion 92 and the first surface portion 43 are in contact with each other, the pattern 83 is interfered with the jig, and the paint of the pattern 83 does not reach the first surface portion 43. However, in the present embodiment, as described above, the first surface portion 43 is located between the second surface portions 44A and 44B, and the second surface portion 44B is disposed at the position continuous to the innermost diameter portion 93. Accordingly, since the pad 81 can be inserted to the back side (the other end side) of the first surface portion 43 on which the printing is performed, the paint of the pattern 83 can reach the first surface portion 43, and the printing can be performed. Therefore, as in the first embodiment, the accuracy of printing on the first surface portion 43 can be improved, and the fine pattern portion 42 can be formed. Therefore, in a case in which the zoom ring 90 is rotated, the sensor 36 can detect the rotation position of the zoom ring 90 with a high resolution.

In addition, by forming the pattern portion 42 formed on the zoom ring 90 via the printing, the same effects as in the first embodiment, such as the size reduction of the lens barrel 12, the cost reduction, ease of steps, and reduction in the number of steps, can be obtained.

### Third Embodiment

In the first embodiment, the flange portion 45 as the stepped portion is provided separately from the first surface portion 43, and the first pattern portion 42A is printed on the first surface portion 43, but the present invention is not limited to this, and in the following third embodiment, the stepped portion has the first surface portion, and the first pattern portion is printed on the first surface portion.

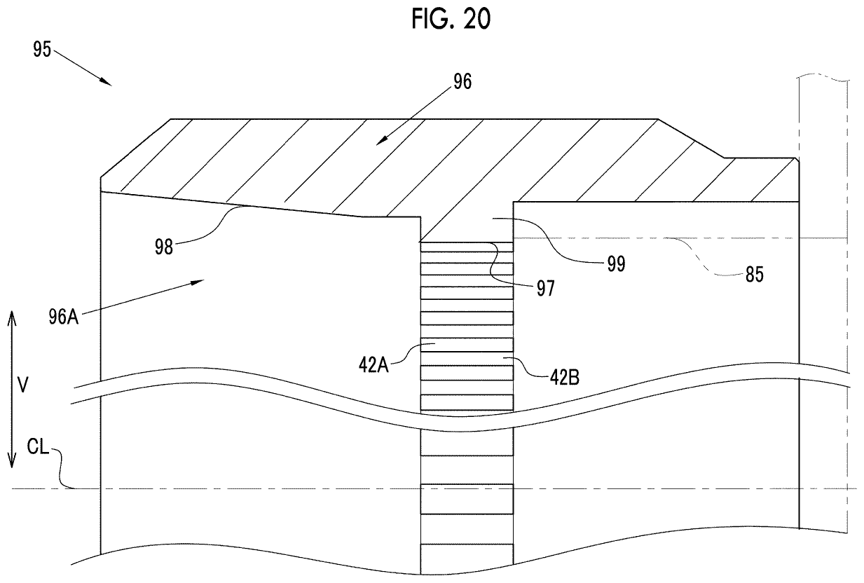

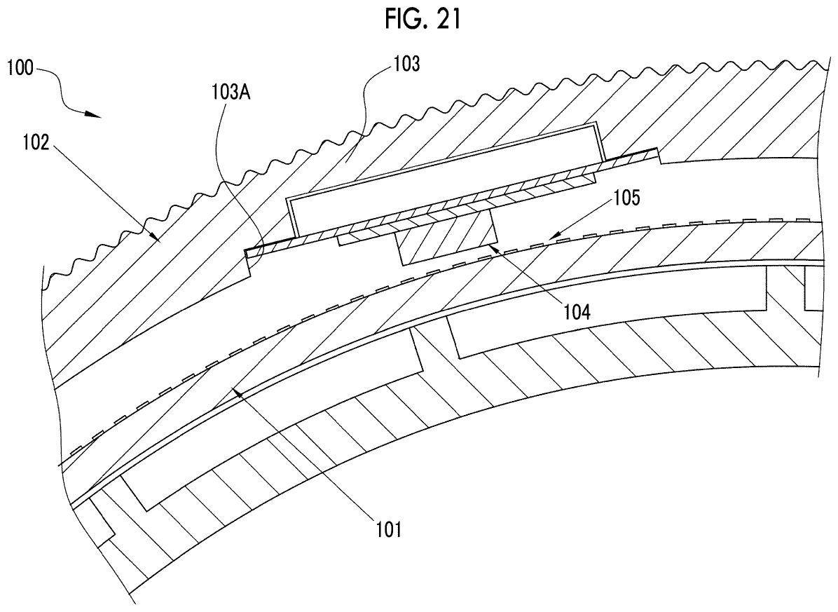

As shown in FIG. 20, the zoom ring 95 according to the present embodiment comprises a ring member 96 and the pattern portion 42. The zoom ring 95 corresponds to an operation ring in the claims. It should be noted that the configuration of the lens device, such as the imaging optical system 22 and the electric zoom mechanism 25, except for the zoom ring 95, is the same as the configuration in the above-described embodiment, and the description thereof will be omitted. The same applies to the pad 81, the pad plate 82, and the like in a case in which the pattern portion 42 is printed on the ring member 96.

The ring member 96 includes a resin member and has the same material as the ring member 41 according to the first embodiment. An inner peripheral surface 96A of the ring member 96 has a first surface portion 97, a second surface portion 98, and a flange portion 99. In the present embodiment, the second surface portion 98 is located on one end side in the rotation axis CL direction of the ring member 96, and the flange portion 99 is located on the other end side thereof. It should be noted that, for one end side and the one end side, in a case in which the ring member 96 is incorporated in the lens barrel body 21, one end side and the other end side are the subject side and the imaging element side, respectively, as in the first embodiment.

The second surface portions 98 are inclined with respect to the rotation axis CL of the ring member 96, as in the second surface portions 44A and 44B according to the first embodiment. The flange portion 99 corresponds to a stepped portion in the claims. The flange portion 99 is located inside the second surface portion 98 in the radial direction V of the ring member 96. The flange portion 99 has the first surface portion 97. Specifically, the first surface portion 97 is provided at a position at which the inner diameter of the flange portion 99 is minimized. The first surface portion 97 is a surface parallel to the rotation axis CL, as in the first surface portion 43 according to the first embodiment, and the first pattern portion 42A is printed as in the first surface portion 43.

The step of manufacturing the zoom ring 95 is the same as the step of manufacturing the zoom ring 23 according to the first embodiment, and in the step of printing the pattern portion 42 on the first surface portion 97, the pad printing is performed in the same manner as in the first embodiment. In a case in which the pattern 83 is transferred from the pad 81, the jig 85 comes into contact with the flange portion 99 to perform the registration. It should be noted that, in this case, the jig 85 is located outside the first surface portion 97 in the radial direction V (position indicated by a two-dot chain line). In this case, since the pad 81 can be inserted into the back side (the other end side) of the first surface portion 97 on which the printing is performed after passing through the flange portion 99, the paint of the pattern 83 can reach the first surface portion 97, and the printing can be performed. As a result, the same effects as those of the first and second embodiments, that is, the accuracy of the printing on the first surface portion 97 can be improved, and the fine pattern portion 42 can be formed. Therefore, in a case in which the zoom ring 95 is rotated, the sensor 36 can detect the rotation position of the zoom ring 95 with a high resolution.

In addition, by forming the pattern portion 42 formed on the zoom ring 95 via the printing, the same effects as in the first and second embodiments, such as the size reduction of the lens barrel 12, the cost reduction, ease of steps, and reduction in the number of steps, can be obtained.

### Fourth Embodiment

In each of the above-described embodiments, the pattern portion is formed on the ring member constituting the zoom ring, and the sensor 36 is attached to the lens barrel body 21, but the present invention is not limited to this, and in the following fourth embodiment, the pattern portion is formed on the lens barrel body 21, and the sensor is attached to the ring member.

As shown in FIG. 21, the lens barrel 100 according to the present embodiment comprises a lens barrel body 101 and a zoom ring 102. It should be noted that the configuration of the lens device, such as the imaging optical system 22 and the electric zoom mechanism 25, other than the lens barrel body 101 and the zoom ring 102 is the same as the configuration in the above-described embodiment, and the description thereof will be omitted.

The zoom ring 102 comprises a ring member 103 and a sensor 104. The sensor 104 is the same component as the sensor 36 according to the first embodiment. The sensor 104 is attached to an opening portion 103A formed in the ring member 103. The sensor 104 is disposed at a position facing the outer peripheral surface of the lens barrel body 101.

A pattern portion 105 is formed on the outer peripheral surface of the lens barrel body 101. The pattern portion 105 is formed by performing the printing on the outer peripheral surface of the lens barrel body 101, as in the pattern portion 42 according to the first embodiment. The pattern portion 105 has the same configuration as the pattern portion 42 according to the first embodiment in that the pattern portion 105 has the first pattern portion having the first light reflectivity and the second pattern portion having the second light reflectivity, the first light reflectivity is higher than the second light reflectivity, and in the configuration of the first pattern portion and the second pattern portion, the configuration of the paint applied to the first pattern portion, and the like. In the step of printing the pattern portion 105 on the outer peripheral surface of the lens barrel body 101, the pad printing is performed in the same manner as in the first embodiment.

In each of the above-described embodiments, the hardware structure of the processing units that execute various types of processing, such as the lens control unit 51 and the camera body control unit 61, is various processors as shown below. The various processors include a central processing unit (CPU), which is a general-purpose processor that executes software (program) and that functions as various processing units, a graphical processing unit (GPU), a programmable logic device (PLD), which is a processor having a circuit configuration changeable after the manufacture, such as a field programmable gate array (FPGA), and a dedicated electric circuit, which is a processor having a circuit configuration specifically designed to execute various types of processing.

One processing unit may be configured by one of these various processors, or may be configured by a combination of two or more same or different types of processors (for example, a plurality of FPGAs, a combination of a CPU and an FPGA, or a combination of a CPU and a GPU). In addition, a plurality of the processing units may be configured by one processor. As an example in which the plurality of processing units are configured by one processor, first, there is a form in which one processor is configured by a combination of one or more CPUs and software, and this processor functions as the plurality of processing units, as represented by a computer, such as a client or a server. Second, as typified by a system on a chip (SoC) or the like, there is a form in which a processor, which realizes the functions of the entire system including the plurality of processing units with a single integrated circuit (IC) chip, is used. As described above, various processing units are configured by one or more of the various processors described above, as the hardware structure.

Further, the hardware structure of these various processors is, more specifically, an electric circuit (circuitry) in a form of a combination of circuit elements, such as semiconductor elements.

It should be noted that, in each of the above-described embodiments, an example has been described in which the operation ring is applied to the zoom ring, but the present invention is not limited to this, and the operation ring may be applied to the focus ring, or may be applied to a stop adjustment ring that operates the stop mechanism. The lens device according to the embodiment of the present invention can be applied to a lens barrel of a smartphone, a video camera, or the like, in addition to the lens barrel of the digital camera.

### EXPLANATION OF REFERENCES

10: digital camera
11: camera body
11A: grip portion
12: lens barrel
13: lens mount
13A: imaging aperture
14: release switch
16: imaging element
17: body-side signal contact
21: lens barrel body
21A: opening portion
22: imaging optical system
22A: filter
22B: first lens group
22C: second lens group
22D: stop
22E: third lens group
22F: fourth lens group
22G: fifth lens group
22H: stop aperture
23, 90, 95, 102: zoom ring
24: focus ring
25: electric zoom mechanism
26: focus mechanism
27: lens mount
28: lens-side signal contact
29: attachment member
31: lens holding frame
32: guide shaft
33: lead screw
33A: screw
34: motor
35: zoom carriage
35A: rack gear
36: sensor
36A: light-emitting diode (LED)
36B, 36C, 36D: light-receiving integrated circuit (IC)
37: lens holding frame
38: sensor
41, 91, 96, 103: ring member
41A: inner peripheral surface
41B: outer peripheral surface
42: pattern portion
42A: first pattern portion
42B: second pattern portion
43: first surface portion
44A: second surface portion
44B: second surface portion
45: flange portion
51: lens control unit
52: motor driver
53: VCM driver
61: camera body control unit
62: shutter unit
63: shutter motor
64: motor driver
65: image memory
66: busline
67: image data processing unit
68: display driver
69: image display unit
71: card interface (I/F)
72: memory card
81: pad
81A: corner portion
82: pad plate
82A: recess portion
83: pattern
85: jig
91A: inner peripheral surface
92: stepped portion
93: innermost diameter portion
96: ring member
96A: inner peripheral surface
97: first surface portion
98: second surface portion
99: flange portion
100: lens barrel
101: lens barrel body
102: zoom ring
103: ring member
103A: opening portion
104: sensor
105: pattern portion
CL: rotation axis
OA: optical axis
P: phase
R: circumferential direction
S: space
S11 to S14: step
T1, T2: width
V: radial direction
Vout1, Vout2: two-phase signal
α1, α2: inclination angle

What is claimed is:

1. An operation ring comprising:
a ring member including a resin member; and
a pattern portion serving as an indicator of a rotation operation of the ring member,
wherein the pattern portion has a first pattern portion having first light reflectivity and a second pattern portion having second light reflectivity,
the first light reflectivity is higher than the second light reflectivity,
an inner peripheral surface of the ring member has a first surface portion parallel to a rotation axis of the ring member and a second surface portion inclined with respect to the rotation axis, and
printing is performed on the first surface portion to form the pattern portion,
wherein the second surface portion has an one-end-side second surface portion located on one end side in an axial direction of the rotation axis and an other-end-side second surface portion located on the other end side,
the first surface portion is located between the one-end-side second surface portion and the other-end-side second surface portion in the axial direction,
the ring member has a stepped portion located outside or inside the first surface portion in a radial direction,
in a case in which the stepped portion is located outside the first surface portion in the radial direction, an innermost diameter portion in which an inner diameter of the ring member is minimized is present inside the first surface portion in the radial direction, and
the other-end-side second surface portion is disposed at a position continuous to the innermost diameter portion.

2. The operation ring according to claim 1,
wherein the first pattern portion coated with paint is formed on the first surface portion.

3. The operation ring according to claim 2,
wherein the paint contains a metal material, and
a mixing ratio of the metal material in the paint is 25% or more and 45% or less.

4. The operation ring according to claim 1,
wherein a first inclination angle at which the one-end-side second surface portion is inclined with respect to the axial direction is larger than a second inclination angle at which the other-end-side second surface portion is inclined with respect to the axial direction.

5. The operation ring according to claim 1,
wherein, in a case in which the stepped portion is located inside the first surface portion in the radial direction, the one-end-side second surface portion and the other-end-side second surface portion are located outside the stepped portion in the radial direction.

6. The operation ring according to claim 1,
wherein the ring member has a stepped portion located inside the second surface portion in a radial direction, and
the stepped portion has the first surface portion, in which the first pattern portion is printed on the first surface portion.

7. The operation ring according to claim 1,
wherein a material of the operation ring is a carbon fiber composite material.

8. The operation ring according to claim 1,
wherein, in the pattern portion, the first pattern portion and the second pattern portion are alternately disposed in a circumferential direction of the operation ring.

9. The operation ring according to claim 8,
wherein the first pattern portion and the second pattern portion are disposed to have the same width.

10. The operation ring according to claim 9,
wherein the width is 0.2 mm or more and 0.3 mm or less.

11. A lens device comprising:
the operation ring according to claim 1;
an optical system; and
an electric zoom mechanism that drives a zoom lens group that is a part of the optical system, in accordance with rotation of the operation ring.

12. The lens device according to claim 11,
wherein the optical system includes at least the zoom lens group, a first lens group, a filter, and a stop,
the filter has a maximum outer diameter portion larger than a maximum outer diameter portion of the first lens group and is located on a subject side with respect to the first lens group,
the zoom lens group is located between the first lens group and the stop and on the subject side with respect to the stop, and
the pattern portion is located between the maximum outer diameter portion of the first lens group and the maximum outer diameter portion of the filter.

13. A method of manufacturing an operation ring, the method comprising:
a step of forming a ring member including a resin member, the ring member having, on an inner peripheral surface, a first surface portion parallel to a rotation axis of the ring member and a second surface portion inclined with respect to the rotation axis; and
a step of performing printing on the first surface portion to form a pattern portion having a first pattern portion having first light reflectivity and a second pattern portion having second light reflectivity,
wherein the second surface portion has an one-end-side second surface portion located on one end side in an axial direction of the rotation axis and an other-end-side second surface portion located on the other end side,
the first surface portion is located between the one-end-side second surface portion and the other-end-side second surface portion in the axial direction,
the ring member has a stepped portion located outside or inside the first surface portion in a radial direction,
in a case in which the stepped portion is located outside the first surface portion in the radial direction, an innermost diameter portion in which an inner diameter of the ring member is minimized is present inside the first surface portion in the radial direction, and
the other-end-side second surface portion is disposed at a position continuous to the innermost diameter portion.
